(19) United States
(12) Patent Application Publication
(10) Pub. No.: US 2006/0268943 A1
(43) Pub. Date: Nov. 30, 2006

(54) Methods, systems, and storage media for data encapsulation in networks

(75) Inventors: Casimer M. DeCusatis, Poughkeepsie, NY (US); Thomas A. Gregg, Highland, NY (US)

Correspondence Address: CANTOR COLBURN LLP-IBM POUGHKEEPSIE, 55 GRIFFIN ROAD SOUTH, BLOOMFIELD, CT, 06002, US

(73) Assignee: INTERNATIONAL BUSINESS MACHINES CORPORATION, ARMONK, NY (US)

(21) Appl. No.: 11/129,920

(22) Filed: May 16, 2005

(51) Int. Cl. H04J 3/02

(52) U.S. Cl. 370/539

(57) ABSTRACT

Methods, systems, and storage media enable the transport of InfiniBand (IB) data over a synchronous optical network (SONET) using generic frame procedure (GFP) encapsulation. User protocol identifiers for IB data in a GFP-SONET frame are defined. A process for maintaining running disparity of data during GFP encapsulation of IB data is provided. Data rate adaptation for this encapsulation is also provided. A simple, cost-effective scheme for data rate compression ensures that IB data is contained within a minimum SONET data rate traffic.

### BACKGROUND OF THE INVENTION

1. Field of the Invention

The present invention relates generally to network computing and wavelength division multiplexing (WDM) and, in particular, to InfiniBand encapsulation in synchronous optical networks (SONET) using Generic Frame Procedure (GFP).

2. Description of Related Art

Some clusters of servers have InfiniBand (IB) channels interconnected through a switch fabric. Other servers and storage products include various IB link widths (e.g., 1X, 4X, 8X and 12X) and various data rates per link (e.g., 2.5 Gbit/s, 5 Gbit/s double data rate, and 10 Gbit/s quad data rate). Many of these applications include extension of IB links over long distances (e.g., tens of km) by using wavelength division multiplexing (WDM) technology. There is a trend towards using the public telephone company infrastructure by transporting data traffic over SONET networks.

G.7041 is a GFP standard from the International Telecommunications Union (ITU) that allows standard datacom protocols with 8B/10B data encoding, such as Fibre Channel to be encapsulated into a SONET/synchronous digital hierarchy (SDH) compliant frame structure so that they can be transported across installed SONET networks. Because there is a large amount of SONET infrastructure installed by telecom carriers and other service providers, GFP is one means for allowing enterprise systems to carry data traffic over existing SONET networks at low cost. As a result, channel extensions for disaster recovery applications may be over hundreds or thousands of km. Many wavelength division multiplexing (WDM) equipment manufactures are adopting GFP transport. However, GFP transport does not currently include the technical requirements to transport these links. There is a need for a way to encapsulate IB channels into GFP frames to enable long distance links in a cost-effective manner.

### BRIEF SUMMARY OF THE INVENTION

The present invention is directed to methods, systems, and storage media for data encapsulation in networks.

One aspect is a system for data encapsulation in networks, including two computers and a SONET network connecting them. The first computer has a link to a first networking device. The first networking device includes a mapping process to encapsulate data into synchronous optical network (SONET) frames using generic frame procedure (GFP). The mapping process sets a user payload identifier (UPI) to a unique value indicating a protocol of the data being encoded or a client signal failure. The second computer has a link to a second networking device. The second networking device includes a de-mapping process to receive and decode the SONET frames. The first and second networking devices are connected to the SONET network.

Another aspect is a method for data encapsulation in networks. A unique user protocol identifier (UPI) is defined for data in a generic frame procedure (GFP) frame. The data is in a protocol other than synchronous optical network (SONET) and the unique UPI indicates that protocol. A running disparity of the data during GFP encapsulation of the data is maintained. The data is transported over a SONET network. A further aspect is a storage device storing instructions for performing this method.

### BRIEF DESCRIPTION OF THE DRAWINGS

These and other features, aspects, and advantages of the present invention will become better understood with regard to the following description, appended claims, and accompanying drawings, where:

FIG. 1 is a block diagram illustrating an exemplary environment for operation of IB links over SONET networks;

FIG. 2 is a block diagram illustrating a conventional GFP mapping procedure;

FIG. 3 is a block diagram illustrating an exemplary embodiment of GFP header fields;

FIG. 4 is a block diagram illustrating an exemplary embodiment of propagating loss of signal (or loss of light) and loss of sync conditions across a network;

FIG. 5 is a block diagram illustrating an exemplary embodiment of mapping IB data in a fashion that maintains running disparity of the data;

FIG. 6 is a block diagram illustrating an exemplary embodiment of data rate adaptation for IB data encapsulation via GFP; and

FIG. 7 is a block diagram illustrating an exemplary embodiment of using data rate compression in an IB encapsulation scheme.

### DETAILED DESCRIPTION OF THE INVENTION

Exemplary embodiments are directed to methods, systems, and storage media for data encapsulation in networks. In one exemplary embodiment, InfiniBand channels are encapsulated into SONET frames using GFP.

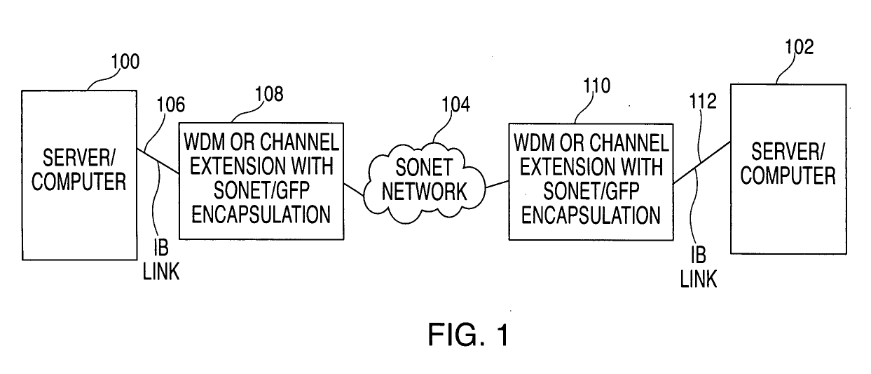

FIG. 1 illustrates an exemplary environment for operation of IB links over SONET networks. In this example, there is a server computer 100 connected to a server computer 102 by a SONET network 104. The server computer 100 has a link 106 to a networking device 108, e.g., WDM or channel extension with SONET/GFP encapsulation 108 that implements a mapping process (IB to SONET). The resulting SONET signal is sent over the SONET network 104 and received by another networking device 110, e.g., WDM or channel extension with SONET/GFP encapsulation that implements a de-mapping process (SONET to IB) and hands off another link 112 to the server computer 102. Exemplary embodiments may reside in or be a part of network devices 108, in server computers 100, 102, in storage control units (not shown), storage devices (not shown), or other devices.

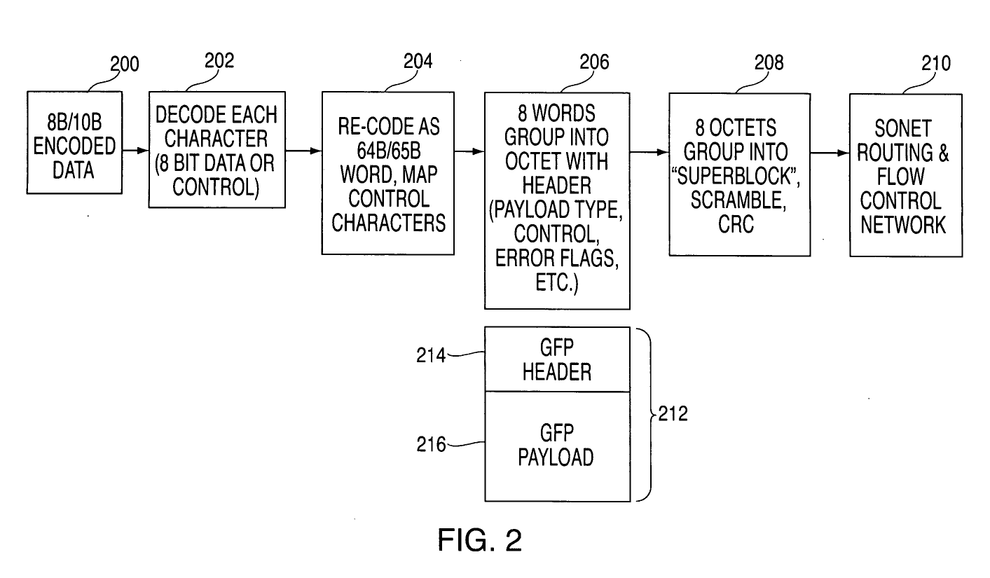

FIG. 2 illustrates a conventional GFP mapping procedure at a high level. Starting with 8B/10B encoded data at 200, each character is decoded, resulting in the original 8-bit data or control characters. The following table shows some exemplary GFP data and control character mapping.

TABLE 1
GFP data and control character mapping

| | | | 64/65 4 bit |
|---|---|---|---|
| Name | RD− | RD+ | mapping |
| K28.0 | 001111 0100 | 110000 1011 | 0000 |
| K28.1 | 001111 1001 | 110000 0110 | 0001 |
| 10B_err | not recognized | not recognized | 1100 |
| GFP idle 65B_pad | not recognized | not recognized | 1101 |

Then, to make the data compatible with SONET, the data is re-coded as 64B/65B word and control characters are mapped at 204. The data is formatted into a SONET frame at 206 and 208 by grouping eight words into an octet with a header (i.e., payload type, control error flags, etc.) and by grouping eight octets into a superblock, resulting in a SONET frame 212 that is compatible with SONET routing and flow control. The SONET frame 212 is sent over the network at 210. The SONET frame 212 has a GFP header 214 and a GFP payload 216.

The GFP standard covers a limited number of protocols and does not include InfiniBand protocol. Exemplary embodiments include modifications to GFP to encapsulate InfiniBand data into SONET frames. Once received, the SONET frame is de-mapped to extract the InfiniBand data. The de-map process follows the InfiniBand standard. A buffer may be used to store data during the de-map process, which may contain any number of characters. In an exemplary embodiment, the de-map buffer holds 3-12 characters.

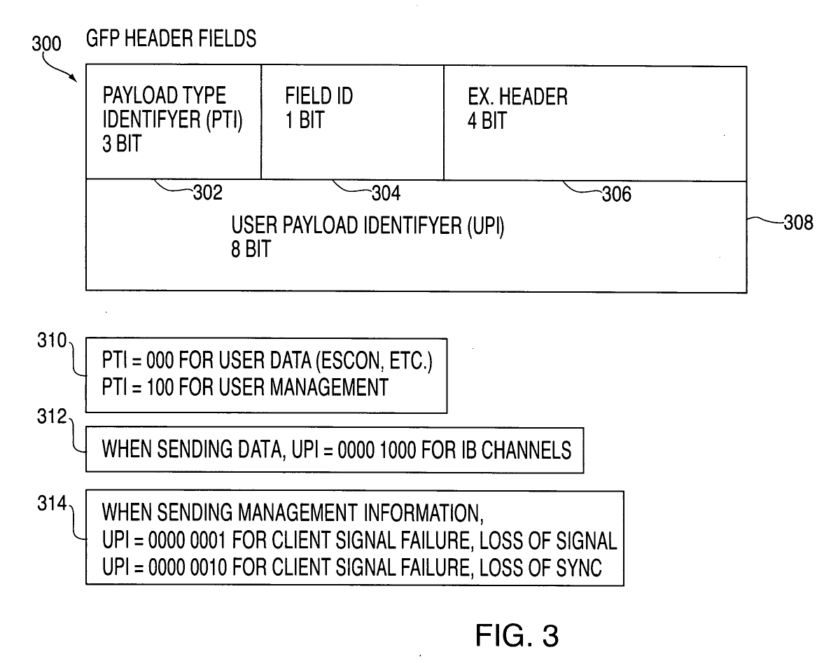

FIG. 3 illustrates an exemplary embodiment of GFP header fields. GFP header fields 300 include payload type identifier (PTI) 302, field identifier 304, extension header 306, and user payload identifier (UPI) 308. The PTI indicates the kind of data the system started with before the system performed the encoding. In this example, PTI is a three bit field with sample PTI values 310, PTI=000 for user data and PTI=100 for user management. In this example, UPI 308 is an 8-bit sequence used to identify the source of the information being mapped into SONET. For example, a unique UPI value 312 is 0000 1000 indicating the IB protocol for IB channels. In this example, UPI values 314 are 000 0001 for the client signal failure loss of signal and 0000 0010 for client signal failure loss of sync.

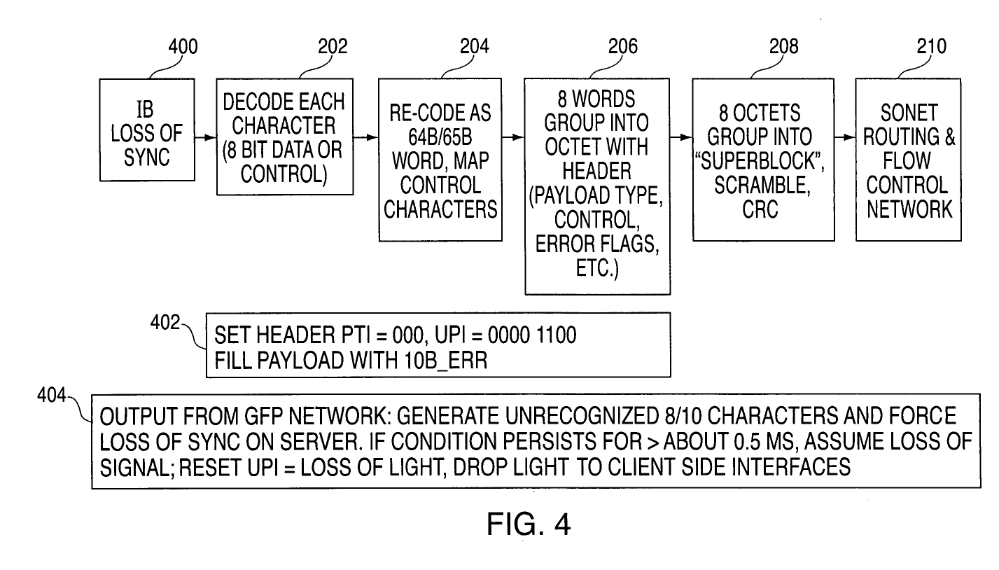

FIG. 4 illustrates an exemplary embodiment of propagating loss of signal (or loss of light) and loss of sync conditions across a network. This is an exemplary method for running InfiniBand data through a GFP mapper, including responding to conditions of loss of signal (or loss of light) and loss of sync. In this example, there is an initial condition of loss of sync 400. Each character is decoded at 202, re-coded as a 64B/65B word and control characters are mapped. Then at 204, sets of 8 words are grouped into octets with a header and at 206, 8 octets are grouped into superblocks, scrambled, and a CRC is computed at 208. Finally at 210, the SONET frames are routed and flow over the network.

Because SONET does not recognize the control character for loss of sync, something needs to be done that will be interpreted as a loss of sync at the other end of the transmission. Instead of placing data in the payload, the payload is filled with the special character 10B_err and values are set at 402 so that PTI=000 and UPI=0000 1100. SONET does recognize a frame with a payload filled with the special character 10B_err as an error condition on the link. When that propagates through the SONET network and arrives at the de-mapper on the other side, the de-mapper attempts to open the frame and does not recognize the 10B_err characters and simply passes the frame to the server. The server also does not recognize the10B_err characters and as well; thus, forcing loss of sync. At 404, the output from the GFP network includes generating unrecognized 8/10 characters and forcing loss of sync on the server. If the loss of sync condition persists for greater than a timeout interval (e.g., about 0.5 ms), then loss of signal is assumed. At this point, UPI is reset to loss of light, and the light is dropped to client-side interfaces in fiber optics networks, completing the process of propagation of loss of sync and loss of signal by the mapper and de-mapper.

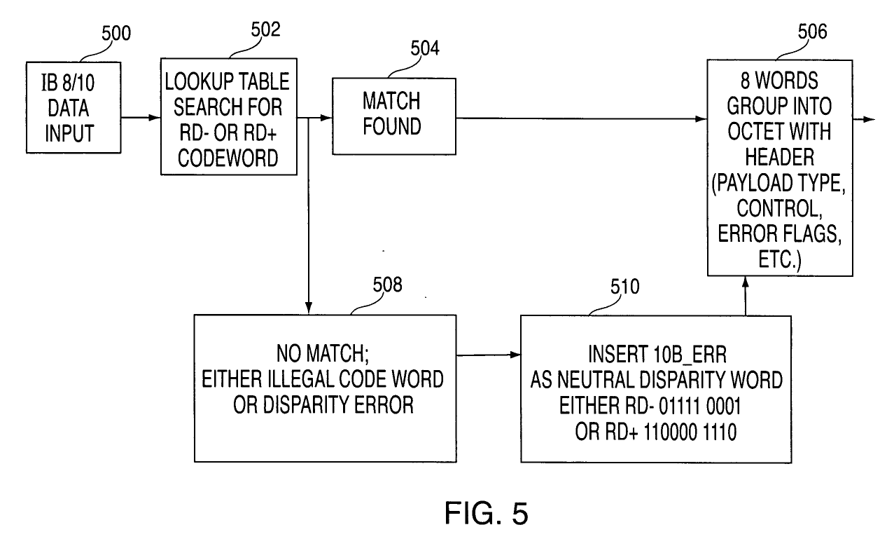

FIG. 5 illustrates an exemplary embodiment of mapping IB data in a fashion that maintains running disparity of the data. Each data word, which is an IB frame 500 that is encoded with 8/10 encoding schemes, is compared at 502 to entries in a lookup table. The lookup table has a predefined list of positive and negative running disparity code words. It is determined whether the current IB frame 500 is a valid data block, (i.e. matches an entry in the table). If a match of the right disparity is found at 504, then the normal encoding process is performed at 506, as described in FIG. 4. If no match is found, then the current IB frame is either an illegal code word or a disparity error at 508. In both cases when no match is found, the special character 10B_err, which is a neutral disparity word, is inserted into the payload at 510 in place of the IB frame that did not match the lookup table entries. There are two possible 10B_err words, either RD −001111 0001 or RD +110000 1110. A neutral disparity word has the same number of zeros and ones so that it does not change the disparity of the data stream. This prevents the problem where illegal code words or disparity errors build up and eventually throw off the running disparity of the link.

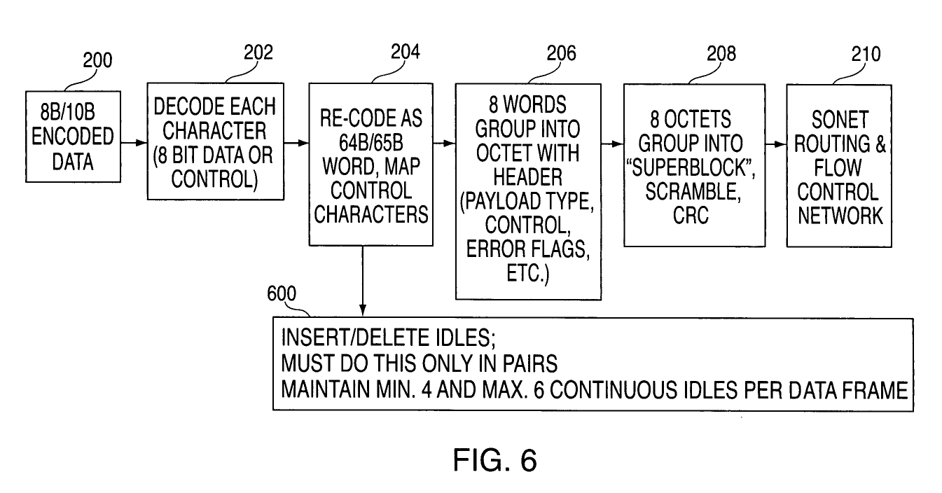

FIG. 6 illustrates an exemplary embodiment of data rate adaptation for IB data encapsulation via GFP. Again, the mapping process as shown in FIGS. 2 and 4 is shown again here at 200, 202, 204, 206, 208, and 210. However, at 204 data rate adaptation is performed. There is always a particular tolerance specified on the running data rate. Usually, tolerances are fairly small. However tolerances become significant at the level of mapping individual data frames. For example, when a mapper is placed in a network and the IB (inbound) link has one tolerance and the SONET (outbound) link has another tolerance on its data rate then there is a synchronization problem.

Data rate adaptation is performed by either inserting or deleting idle characters in the input data stream at 600. Idle characters are a predefined set of pseudo-random data characters. In one embodiment, the idle characters are a pseudo random data sequence generated by a 11^{th} order LFSR=X¹¹+X⁹+1 as noted in the Infiniband Architecture Specification. The idle characters are chosen by the LFSR and may have positive, negative, or neutral disparity. In exemplary embodiments, idle characters are inserted and deleted in pairs (one positive and one negative) in the mapping process. The idle characters are inserted between start-of-frame and end-of-frame designators. Because the data rates are often different, insertions and deletions are performed frequently. There may be boundaries on how many consecutive idle characters can appear in the data stream.

Typically, at the other end, any extra idle characters are not adapted during the de-mapping process, but passed off to the server at the other end. The de-mapping process can either retain idle characters or discard idle characters as long line packet ordering protocols are followed, such as the line packet ordering protocols identified in the Infiniband Architecture Specification. As a result, the performance of the adapter at the other end might be impeded. In an exemplary embodiment, at least 4 consecutive idle characters and no more than 6 idle characters per data frame are inserted during the encoding process. This works well with many InfiniBand adapters. Other exemplary embodiments set various other limits and boundaries on consecutive idle characters depending on the system architecture.

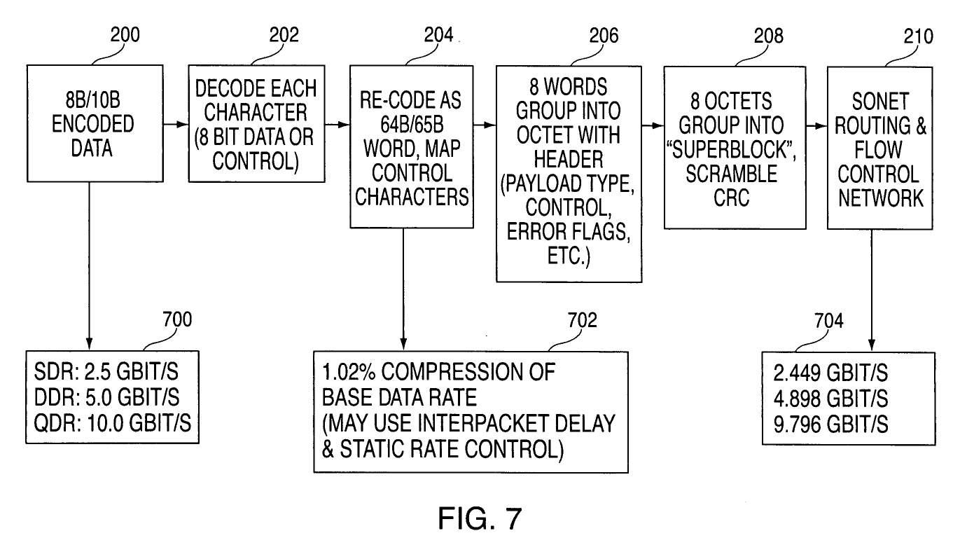

FIG. 7 illustrates an exemplary embodiment of using data rate compression in an IB encapsulation scheme. The data rate compression function is an optional feature in exemplary embodiments. Again, the mapping process as shown in FIGS. 2 and 4 is shown again here at 200, 202, 204, 206, 208, and 210. However, data rate compression is added at 700, 702, and 704. Recall that there are different tolerances on data rates. There are standard data rates for IB and standard data rates for SONET that differ. IB defines three possible data rates as shown at 700: single data rate (SDR) is 2.5 Gbit/s, double data rate (DDR) is 5.0 Gbit/s, and quad data rate (QDR) is 10.0 Gbit/s. SONET defines three different data rates as shown at 704: 2.449 Gbit/s, 4.898 Gbit/s, and 9.796 Gbit/s. There are tolerances associated with all of these data rates. Suppose a 2.5 Gbit/s signal is incoming. The outgoing data rate of 2.449 Gbit/s is a little too small, so the next higher one, 4.898 Gbit/s could be used, wasting bandwidth. There is a need to avoid wasting bandwidth and save costs. Therefore, if data is slightly compressed so that the smaller data rate could be used, bandwidth is conserved.

During the mapping process at 204, about 1.02% compression of the base data rate is achieved at 702 to squeeze the IB signal down to fit into the lower speed SONET rate. There are various ways compression may be performed. One way is to use a built-in function of the IB protocol called interpacket delay and static rate control, but use it for a different purpose. This function permits a user to adjust the gaps left between packets to save bandwidth for applications that do not use all of the data for some reason. It turns out that this same feature can be used in a new way-to compress the data rate to fit into a standard SONET packet.

Another exemplary embodiment is a method for protocol mapping that involves decoding each 10-bit character of an 8B/10B data sequence and mapping the result into either an 8-bit data character or a recognized control character. This data is then re-encoded as a 64B/65B data sequence, with control characters mapped into a predetermined set of 64/65B control characters. In GFP terminology, the resulting data sequences or control characters are known as words. (This differs from the usual server definition of a word, which is either a 4-byte quantity or a 40-bit string of four 7B/10B characters. In this disclosure, the GFP terminology is used.) A group of 8 such words is assembled into an octet. The octet is provided with additional control and error flags. (This differs from the usual server definition of an octet, which is an 8-bit byte.) A group of 8 (an octet) is then assembled into a superblock, scrambled, and a cyclic redundancy checking (CRC) error check field is added. The resulting frames are compliant with routing through a SONET/SDH network flow control, including quality of service and related features. The original 8/10 encoded data is reassembled at the other end of the network.

An exemplary system defines a number of features needed in order to make IB data frames operate using the above exemplary method. First, a method of handling running disparity of the data upon entering and exiting the GFP network is defined. InfiniBand data uses 8B/10B encoding, which is designed to help reduce bit errors through various methods, such as maintaining DC balance. The DC balance is measured by keeping track of running disparity on code words. The running disparity is either positive—more 1s than 0s have been sent—or negative—more 0s than 1s have been sent. In order to maintain DC balances, each 8-bit character and each of the recognized special control characters have two possible 10-bit encodings. Depending on running disparity, the 8B/10B encoder normally selects which of the two possible encodings to transmit. Specifically, the disparity is maintained if there have been an equal number of 1s and 0s transmitted. Or, the disparity is flipped from either positive to negative or vice-versa. In order to preserve data disparity, it is necessary to have some information about the data structures on an IB channel. Running disparity is adjusted by insertion of appropriate code words. A lookup table is provided to search for the appropriate valid code word—either “+” or “−”, depending on the assumed initial disparity. If no match is found, then either an illegal word or a legal word with a running disparity error was detected. For protocols, such as Fibre Channel, an error code is generated that is mapped into the 64B/65B frame. Because no such error codes were defined for IB traffic, a new GFP code is inserted that corresponds to 8B/10B code violations. Furthermore, the error code is inserted into a neutral disparity sequence that is not recognized as a valid IB code word and different code words are used depending on the beginning running disparity. In one exemplary embodiment, the code word 001111 0100 represents negative initial disparity when the error occurred and the code word 110000 1111 represents positive initial disparity. These codes are recognized by the GFP mapper embedded in the WDM equipment. When the data exits from the GFP mapper at the other end of the network, this error condition is decoded and recognized as an 8B/10B code error, which is handled transparently by the server.

In this exemplary embodiment, the decoded error condition is recognized as an IB protocol specific error. IB defines an interpacket delay mechanism as part of its static rate control, which generally allows the subnet manager to force idle sequences between data packets. This throttles down the bandwidth, for example, when a 12X port is interconnected with a 4X port. Other port rates may be accommodated, such as 8X ports. The interpacket delay mechanism in this exemplary embodiment also facilitates disparity correction.

InfiniBand is a switched fabric with similar security features to Fibre Channel switch fabrics. In particular, any state change that occurs within the IB fabric (e.g., swapped optical cables) propagates a state change notification (e.g., loss of light or loss of sync) to the network endpoints. Training sequences (as defined in the InfiniBand vol. 2 spec, chapter 5) also propagate transparently through a GFP network. These training sequences include states such as polling, sleeping, and configuration of link status. This exemplary embodiment includes handling these kinds of IB protocol-specific signal conditions. The approaches included are similar to those used for other protocols. The architectural differences for IB channels are the character/word counting for the loss of sync algorithm and the time out intervals for the loss of light (signal) as well as the definition for GFP payload identification.

This exemplary embodiment addresses loss of signal and loss of synchronization conditions. GFP mapping includes a client signal fail (CSF) indication that is used to propagate conditions over the GFP network. The payload header of a GFP frame includes a mandatory two-octet field that specifies the content and format of the GFP frame payload. This includes a 3-bit subfield called the payload type identifier (PTI). When PTI is set to 100, the GFP mapper recognizes the payload as management information rather than client data. Once the frame is identified as having management information, an 8-bit field called user payload identification (UPI) is set. For example, UPI=0000 0100 indicates loss of character sync. Both of these states are known as client signal fail (CSF) events. If a CSF event occurs within a GFP data frame, for an IB signal, the remainder of the 64/65 block encoding is filled with 8/10 error codes, which are decoded as data errors by the server at the exit of the GFP network. This forces the remote server into a loss of sync condition with appropriate error handling. If this condition persists for more than the IB link timeout interval (i.e., 0.5 ms) or if loss of light is detected, then the inbound GFP mapper propagates this condition using the corresponding UPI code and the outbound GFP mapper forces a loss of signal condition and associated recovery actions at the downstream server. When IB data is transmitted over the GFP network, there is defined a new UPI for IB data so that when PTI=000 and IB data is used, set UPI=0000 1100.

This exemplary embodiment includes features for an IB link to propagate transparently across a GFP network, including handling running disparity on the links, handling data rate adaptation, propagating loss of light and loss of sync conditions, and managing data rate compression to better utilize lower bandwidth SONET link rates. Some other exemplary embodiments include one or more of the following features: state change propagation (e.g., loss of light, loss of sync), data rate adaptation, data disparity, and data compression.

As described above, the embodiments of the invention may be embodied in the form of computer-implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. A system for data encapsulation in networks, comprising:
a first computer having a link to a first networking device, the first networking device including a mapping process to encapsulate data into synchronous optical network (SONET) frames using generic frame procedure (GFP), the mapping process setting a user payload identifier (UPI) to a unique value indicating a protocol of the data being encoded or a client signal failure;
a second computer having a link to a second networking device, the second networking device including a de-mapping process to receive and decode the SONET frames; and
a SONET network connecting the first and second computers, the first and second networking devices being connected to the SONET network.

2. The system of claim 1, wherein the mapping process includes propagating the client signal failure across the SONET network.

3. The system of claim 2, wherein the client signal failure is loss of signal, loss of light, or loss of sync.

4. The system of claim 2, wherein a GFP payload includes a special character that is not recognized by SONET and is interpreted as loss of sync at the second networking device.

5. The system of claim 1, wherein the protocol is InfiniBand.

6. The system of claim 1, wherein the mapping process includes maintaining running data disparity.

7. The system of claim 6, wherein the mapping process includes attempting to match each data word to entries in a lookup table, the lookup table having predetermined code words.

8. The system of claim 7, wherein the mapping process includes inserting a special character into a GFP payload when no match is found in the lookup table, the special character being a neutral disparity word.

9. The system of claim 1, wherein the mapping process includes data rate adaptation by inserting or deleting idle characters in the input data stream.

10. The system of claim 1, wherein the mapping process includes data rate compression of the base data rate to meet the SONET data rate.

11. The system of claim 10, wherein an interpacket delay and static rate control function is used to compress the incoming data rate to fit into a standard SONET packet.

12. A method for data encapsulation in networks, comprising:
defining a unique user protocol identifier (UPI) for data in a generic frame procedure (GFP) frame, the data being in a protocol other than synchronous optical network (SONET), the unique UPI indicating the protocol;
maintaining running disparity of the data during GFP encapsulation of the data; and
transporting the data over a SONET network.

13. The method of claim 12, further comprising:
propagating a client signal failure across a SONET network.

14. The method of claim 13, wherein the client signal failure is loss of signal, loss of light, or loss of sync.

15. The method of claim 13, wherein a GFP payload includes a special character that is not recognized by SONET and is interpreted as loss of sync at the second networking device.

16. The method of claim 12, wherein the protocol is InfiniBand.

17. The method of claim 12, wherein maintaining running data disparity comprises:
attempting to match each data word to entries in a lookup table, the lookup table having predetermined code words; and
inserting a special character into a GFP payload when no match is found in the lookup table, the special character being a neutral disparity word.

18. The method of claim 12, further comprising:
performing data rate compression of the base data rate to meet the SONET data rate by using an interpacket delay and static rate control function to compress the incoming data rate to fit into a standard SONET packet.

19. A storage medium for storing instructions to perform a method for data encapsulation in networks, the method comprising:
defining a unique user protocol identifier (UPI) for data in a generic frame procedure (GFP) frame, the data being in a protocol other than synchronous optical network (SONET), the unique UPI indicating the protocol;
maintaining running disparity of the data during GFP encapsulation of the data; and
transporting the data over a SONET network.

20. The storage medium of claim 19, further comprising:
performing data rate compression to contain the data within a minimum SONET data rate traffic.
